(19) United States
(12) Patent Application Publication
(10) Pub. No.: US 2004/0027481 A1
(43) Pub. Date: Feb. 12, 2004

(54) Illumination apparatus, camera apparatus, and portable equipment

(76) Inventors: Takao Asai, Osaka (JP); Jun Okazaki, Nara-shi (JP)

Correspondence Address: BIRCH STEWART KOLASCH & BIRCH, PO BOX 747, FALLS CHURCH, VA, 22040-0747, US

(21) Appl. No.: 10/635,023

(22) Filed: Aug. 6, 2003

(30) Foreign Application Priority Data
Aug. 6, 2002 (JP) 2002-228763

(51) Int. Cl. H04N 5/225

(52) U.S. Cl. 348/372

(57) ABSTRACT

Red LED chip(s) 11r, green LED chip(s) 11g, and blue LED chip(s) 11b may be connected in series. In addition, taking Pr to be red intensity, Pg to be green intensity, and Pb to be blue intensity for the same value of electric current, the ratio of the intensities among Pr, Pg, and Pb may be set so as to be 3:7:1, more or less. By integrally mounting such illumination apparatus(es) to portable equipment for illumination when using CCD image pickup element(s) to acquire image(s), improved color reproduction by CCD image pickup element(s) is permitted.

### BACKGROUND OF INVENTION

1. Field of Invention

The present invention pertains to an illumination apparatus employing light emitting diode chip(s), and to a camera apparatus provided with such illumination apparatus(es), and also to portable equipment (e.g., mobile telephones, PDAs (personal digital assistants), etc.) provided with such camera apparatus(es).

2. Conventional Art

Recent-model mobile telephones employ cameras provided thereon in integral fashion, it being possible to use such cameras to shoot full-color still pictures and/or motion video and to send same directly to specific recipients. However, since the sensitivity of the camera may not always encompass a wide range, illumination may be necessary where the photographic subject is itself dark or where the photographic subject is present at a location which is dark.

Some recent-model mobile telephones are therefore equipped with such an illumination apparatus (primarily flashes for shooting still pictures).

For example, there is a mobile telephone having a built-in camera which is manufactured by Toshiba Corp. for J-PHONE (being an abbreviation of J-PHONE Co., Ltd.), and while this mobile telephone is supplied with a flash, the form which this takes is such that the flash must be attached externally to a location provided on the mobile telephone body for connection of a headphone.

Furthermore, there is also a mobile telephone which is provided by cdmaOne (a digital mobile telephone service provided by DDI Cellular Group and IDO), digital cameras for this mobile telephone including a digital camera manufactured by Kyocera Corp. To be used, this digital camera must be connected to an interface of the mobile telephone, neither the camera nor the flash being built into the mobile telephone body.

Neither the flash supplied with the aforementioned mobile telephone having built-in camera which is manufactured by Toshiba Corp. for J-PHONE nor the flash of the digital camera for the mobile telephone provided by cdmaOne is implemented through use of light emitting diode(s) (hereinafter “LED(s)”).

Because mobile telephones are characteristically small in size and are necessarily battery-powered, they cannot use conventional incandescent lamps or the like. But high-luminance semiconductor LEDs would excel in such an application. However, the problem has existed that employment of ordinary LEDs—which are red, green, or the like—for illumination without further modification has only permitted unnatural images to be obtained.

That is, a white (i.e., containing red, green, and blue components) LED would be desirable for illumination even when shooting black-and-white images, and is indispensable when shooting color images.

Moreover, well-known as a white LED is a conventional white LED wherein a blue LED chip is potted with a YAG-type (YAG being an abbreviation for yttrium aluminum garnet) fluorescent substance, the wide emission spectrum centered on yellow which is emitted by the fluorescent substance being combined with the narrow emission spectrum of the blue LED. However, when this type of white LED has been used for illumination with a camera apparatus possessing a CCD (charge coupled device) image pickup element to shoot images, there has been the problem that the large amount of noise has made it impossible to obtain good-quality images.

As can be seen from the spectral distribution of the white LED shown in FIG. 16, the reason for occurrence of noise is the low red intensity.

CCD image pickup elements, being small in size and possessing good sensitivity, excel as image pickup elements for cameras built into mobile telephones. With CCD image pickup elements, images are captured on a color-by-color basis, with signal intensity being used to determine gain for a specific color and with the signals for the other colors being amplified at that same gain. This being the case, CCD image pickup element characteristics are such that where the intensity of the color signal used to determine gain is low, gain will be set to a very high level, causing the other color signals to saturate; and conversely, where the intensity of the color signal used to determine gain is high, gain will be set to a very low level, causing the other color signals to be overwhelmed by noise.

Accordingly, if a white LED is used as illumination source for a camera apparatus possessing a CCD image pickup element, because the intensity of the red component is lower than the intensity of the blue component, noise will result.

### SUMMARY OF INVENTION

The present invention was conceived in light of such state of affairs, it being an object thereof to achieve miniaturization of an illumination apparatus through use of LED(s) as light source(s) and to provide an illumination apparatus permitting attainment of good-quality camera image(s) with adequate consideration having been given to CCD image pickup element characteristics, a camera apparatus equipped with such illumination apparatus(es), and portable equipment equipped with such camera apparatus(es).

An illumination apparatus in accordance with one or more embodiments of the present invention is characterized in that one or more red LED chips, one or more green LED chips, and one or more blue LED chips are connected in series; these chips being capable of being driven by one power supply apparatus. By thus using LEDs connected in series it is possible to achieve miniaturization of the apparatus. Furthermore, operation with one power supply (e.g., battery or the like) is made possible. Moreover, if installed in a camera apparatus possessing CCD image pickup element(s), improved color reproduction by CCD image pickup element(s) is permitted.

Furthermore, an illumination apparatus in accordance with one or more embodiments of the present invention is characterized in that two red LED chips, one green LED chip, and one blue LED chip are connected in series; these four chips being capable of being driven by one power supply apparatus. By thus providing two red LED chips it is possible to increase red signal intensity. As a result, if installed in a camera apparatus possessing CCD image pickup element(s), improved color reproduction by CCD image pickup element(s) is permitted.

Furthermore, an illumination apparatus in accordance with one or more embodiments of the present invention is characterized in that one or more red LED chips and one or more chips comprising one or more blue chips and one or more fluorescent substances are connected in series; these chips being capable of being driven by one power supply apparatus. While the red component would be insufficient with chip(s) comprising blue chip(s) and fluorescent substance(s), addition of red LED(s) hereto makes it possible, where installed in a camera apparatus possessing CCD image pickup element(s), to improve color reproduction by CCD image pickup element(s).

Furthermore, an illumination apparatus in accordance with one or more embodiments of the present invention is characterized in that one or more blue LED chips and one or more chips capable of causing excitation so as to produce red and so as to produce green due to combination of one or more violet chips and one or more fluorescent substances are connected in series; these chips being capable of being driven by one power supply apparatus. While chip(s) comprising violet chip(s) and fluorescent substance(s) permit attainment of two wavelengths, these being red and green, addition of blue LED(s) hereto makes it possible to compensate for the relative weakness of the color at the blue wavelength and makes it possible, where installed in a camera apparatus possessing CCD image pickup element(s), to improve color reproduction by CCD image pickup element(s).

Furthermore, an illumination apparatus in accordance with one or more embodiments of the present invention is characterized in that one or more red LED chips and one or more chips capable of causing excitation so as to produce green and so as to produce blue due to combination of one or more violet chips and one or more fluorescent substances are connected in series; these chips being capable of being driven by one power supply apparatus. While chip(s) comprising violet chip(s) and fluorescent substance(s) permit attainment of two wavelengths, these being green and blue, addition of red LED(s) hereto makes it possible to compensate for the relative weakness of the color at the red wavelength and makes it possible, where installed in a camera apparatus possessing CCD image pickup element(s), to improve color reproduction by CCD image pickup element(s).

Furthermore, a camera apparatus in accordance with one or more embodiments of the present invention is characterized in that one or more of such illumination apparatuses are integrally mounted to the apparatus body for illumination when using one or more CCD image pickup elements to acquire one or more images. Furthermore, at least one gain of at least one of the CCD image pickup element or elements may be set based on one or more signals associated with one or more specific wavelengths (e.g., red signal(s)). Doing so will make it possible to improve color reproduction by CCD image pickup element(s).

Here, taking Pr to be red intensity, Pg to be green intensity, and Pb to be blue intensity for the same value of electric current, it is desirable that the ratio of the intensities among Pr, Pg, and Pb be 3:7:1, more or less (the term “intensity” as used herein means brightness of light emission). Setting same to such ratio will make it possible to achieve most improved color reproduction by CCD image pickup element(s). In testing performed by the present inventors, where the ratio of the intensities among Pr, Pg, and Pb was for example 5:7:1 the green and blue signals were overwhelmed by noise, and where the ratio of the intensities among Pr, Pg, and Pb was 1:7:1 the green and blue signals were saturated, preventing attainment of good-quality images; but where the ratio of the intensities among Pr, Pg, and Pb was 3:7:1 it was possible to obtain good-quality images.

Furthermore, portable equipment in accordance with one or more embodiments of the present invention is characterized in that one or more of such camera apparatuses incorporating illumination apparatus(es) are integrally mounted to the equipment body or bodies. This will make it possible to provide portable equipment (e.g., a mobile telephone) having integrally mounted camera(s) with illumination capability.

### BRIEF DESCRIPTION OF DRAWINGS

FIG. 1 is an explanatory diagram showing an embodiment of a camera-equipped mobile telephone provided with illumination apparatus according to the present invention.

FIG. 2 is an enlarged plan view showing a first working example of an RGB tri-color LED serving as component in the mobile telephone shown in FIG. 1.

FIG. 3 is an explanatory diagram showing an exemplary arrangement of the respective chips in the RGB tri-color LED shown in FIG. 2.

FIG. 4 is a diagram indicating how the respective chips within an RGB tri-color LED might be connected.

FIG. 5 is a circuit diagram showing constitution of drivers for the RGB tri-color LED shown in FIG. 4.

FIG. 6 is a diagram showing spectral distribution of the respective colors RGB emitted by an RGB tri-color LED.

FIG. 7 is a diagram indicating how the respective chips in an illumination apparatus in a second working example might be connected.

FIG. 8 is an explanatory diagram showing how the respective chips in an illumination apparatus in a second working example might be arranged on a board or substrate.

FIG. 9 is a diagram showing spectral distribution of the colors emitted by the respective chips in the illumination apparatus of the second working example.

FIG. 10 is a diagram indicating how the respective chips in an illumination apparatus in a third working example might be connected.

FIG. 11 is a diagram showing spectral distribution of the colors emitted by the respective chips in the illumination apparatus of the third working example.

FIG. 12 is a diagram indicating how the respective chips in an illumination apparatus in a fourth working example might be connected.

FIG. 13 is a diagram showing spectral distribution of the colors emitted by the respective chips in the illumination apparatus of the fourth working example.

FIG. 14 is a diagram indicating how the respective chips in an illumination apparatus in a fifth working example might be connected.

FIG. 15 is a diagram showing spectral distribution of the colors emitted by the respective chips in the illumination apparatus of the fifth working example.

FIG. 16 is a diagram showing spectral distribution of a conventional white LED.

### DESCRIPTION OF PREFERRED EMBODIMENTS

Below, embodiments of the present invention are described with reference to the drawings.

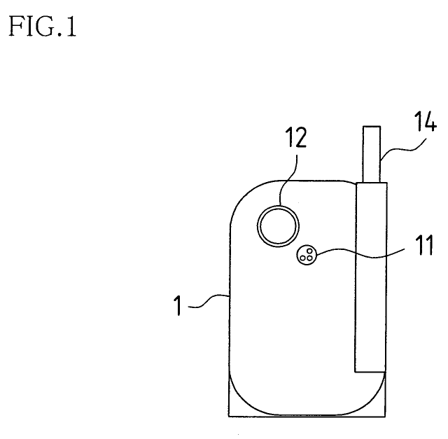

FIG. 1 is an explanatory diagram showing an embodiment of a camera-equipped mobile telephone provided with illumination apparatus according to the present invention.

The mobile telephone of the present embodiment, being a mobile terminal for carrying out communication by way of a wireless communication network, comprises a display component 1 and an operation panel component (not shown). The mobile telephone shown being of the folding type, only the back of display component 1 is shown in the present drawing. Provided at this display component 1 there is an antenna 14, and there are also a number of components which are not shown in the drawing, such as a liquid crystal display panel, speaker(s), and so forth. Furthermore, provided at the operation panel component, not shown, there is an operation keypad comprising number keys, symbol keys, and function keys for use by the user when carrying out setting of various preferences, composition of electronic mail, dialing, and so forth, and there is also a microphone and various other components.

This display component 1 and this operation panel component are connected by way of a hinge or the like, permitting the liquid crystal display panel of display component 1 and the operation keypad of the operation panel component to be housed so as to face each other when in a folded state.

Furthermore, arranged at the back of display component 1 there are a camera apparatus (hereinafter “CCD camera”) 12 comprising CCD image pickup element(s), and an RGB tri-color LED 11 which is a working example (first working example) of a camera illumination apparatus and which is also capable of being used as incoming call indicator lamp. Because the LED chip is small, having thickness on the order of 0.25 mm and external dimensions on the order of 0.3 mm×0.3 mm, it is capable of being built into the mobile telephone body. Note that “RGB” refers to the three primary colors of light, “R” being an abbreviation for “red,” “G” being an abbreviation for “green,” and “B” being an abbreviation for “blue,” and RGB tri-color LED 11 is an LED equipped with three light sources respectively capable of outputting red light, green light, and blue light.

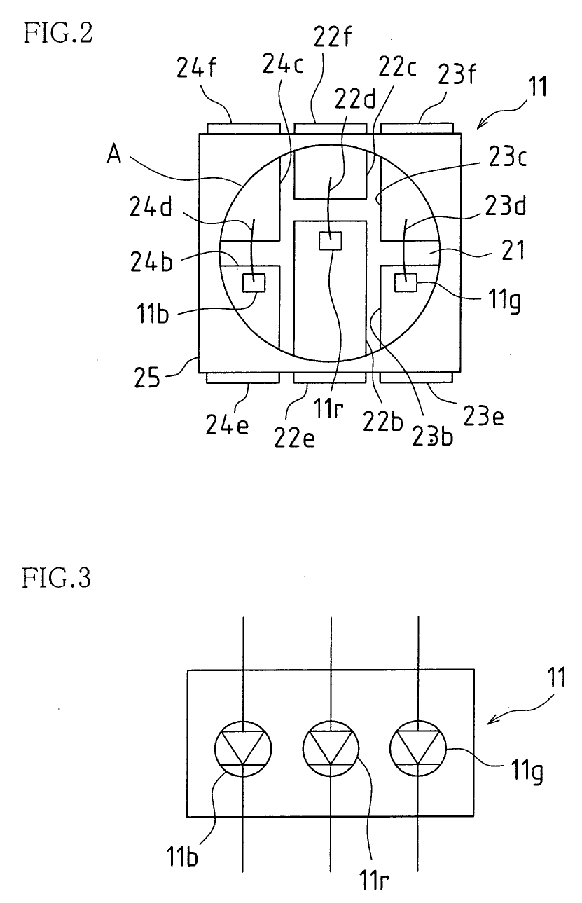

FIG. 2 is an enlarged plan view showing an example of an RGB tri-color LED 11 serving as component in the mobile telephone shown in FIG. 1, and FIG. 3 is an explanatory diagram showing an exemplary arrangement of the RGB tri-color LED 11 shown in FIG. 2.

RGB tri-color LED 11 is equipped with red LED chip 11r arranged at the center of the surface of substrate 21, green LED chip 11g arranged to the lower right of this red LED chip 11r, and blue LED chip 11b arranged to the lower left of this red LED chip 11r.

Furthermore, red LED chip 11r, green LED chip 11g, and blue LED chip 11b are respectively arranged on the surface of substrate 21 by way of interposing first frame 22b, second frame 23b, and third frame 24b. In addition, red LED chip 11r is die bonded to first frame 22b, green LED chip 11g is die bonded to second frame 23b, and blue LED chip 11b is die bonded to third frame 24b. Moreover, red LED chip 11r is wire bonded to fourth frame 22c by way of first Au lead (gold lead) 22d, green LED chip 11g is wire bonded to fifth frame 23c by way of second Au lead 23d, and blue LED chip 11b is wire bonded to sixth frame 24c by way of third Au lead 24d.

In addition, this substrate 21, this red LED chip 11r, this green LED chip 11g, this blue LED chip 11b, this first frame 22b, this second frame 23b, this third frame 24b, this fourth frame 22c, this fifth frame 23c, and this sixth frame 24c are packaged by means of encapsulating resin region 25 formed from phototransmissive resin. Arranged at side faces of this encapsulating resin region 25 there are first terminal 22e which is electrically connected to first frame 22b, second terminal 23e which is electrically connected to second frame 23b, third terminal 24e which is electrically connected to third frame 24b, fourth terminal 22f which is electrically connected to fourth frame 22c, fifth terminal 23f which is electrically connected to fifth frame 23c, and sixth terminal 24f which is electrically connected to sixth frame 24c.

Note that at FIG. 2, in order to more clearly show the structure at the interior of encapsulating resin region 25, that portion of encapsulating resin region 25 indicated as region A has been cut away in order to show substrate 21, red LED chip 11r, green LED chip 11g, blue LED chip 11b, first frame 22b, second frame 23b, third frame 24b, fourth frame 22c, fifth frame 23c, and sixth frame 24c.

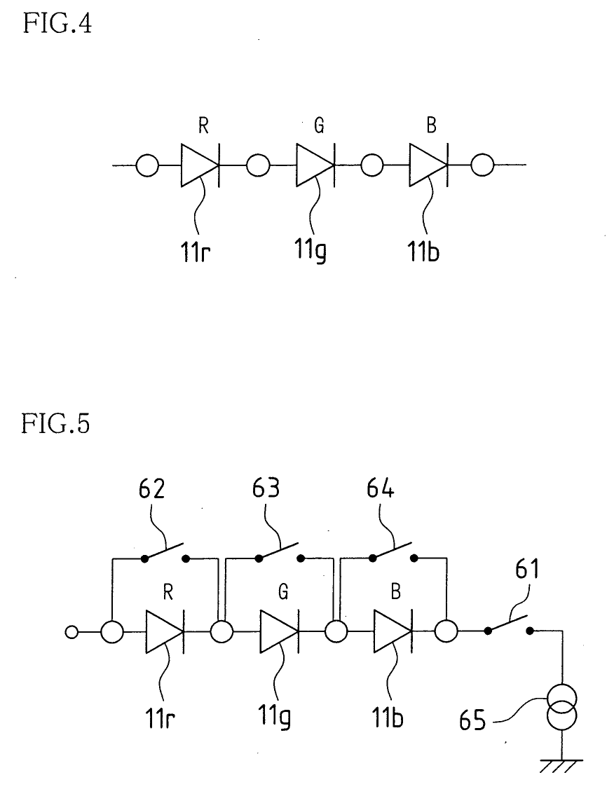

FIG. 4 shows an example of how red LED chip 11r, green LED chip 11g, and blue LED chip 11b within RGB tri-color LED 11 might be connected, these chips 11r, 11g, and 11b being connected in series in the first working example.

Furthermore, FIG. 5 shows drivers for the RGB tri-color LED 11 shown in FIG. 4. Employed here are drivers comprising first switch 61, second switch 62, third switch 63, fourth switch 64, and constant-current circuit 65; and in addition to illumination, the constitution can also used as incoming call indicator lamp by turning respective switches 61, 62, 63 ON and OFF.

Describing this in more specific detail, red LED chip 11r, green LED chip 11g, blue LED chip 11b, and first switch 61 are connected in series between power supply and ground; second switch 62 is connected in parallel across red LED chip 11r; third switch 63 is connected in parallel across green LED chip 11g; and fourth switch 64 is connected in parallel across blue LED chip 11b. In addition, during receipt of incoming call or calls, RGB tri-color LED 11 emits light in prescribed pattern or patterns and in prescribed color or colors as a result of first switch 61 being turned ON and as a result of second through fourth switches 62 through 64 being turned ON in selectively combined fashion; and when used for illumination, RGB tri-color LED 11 emits light as a result of only first switch 61 being turned ON, with second through fourth switches 62 through 64 being turned OFF. Note that where RGB tri-color LED 11 is to be used only for illumination, second through fourth switches 62 through 64 need not be present.

That is, when used for illumination, RGB tri-color LED 11 may be driven by a single power supply and may be made to light or not light depending on whether first switch 61 is turned ON or OFF. In such a case, the same value of electric current (e.g., 35 mA) will accordingly be supplied to all of the LED chips 11r, 11g, 11b. Where red LED chip 11r, green LED chip 11g, and blue LED chip 11b are connected in series in this fashion, constant-current circuit 65 may be employed in order to maintain constant current at the drivers. Furthermore, because it is sufficient that power supply voltage be greater than or equal to the sum of the forward voltages of respective LED chips 11r, 11g, 11b; i.e., greater than or equal to 11V, driving may be accomplished by means of battery or batteries.

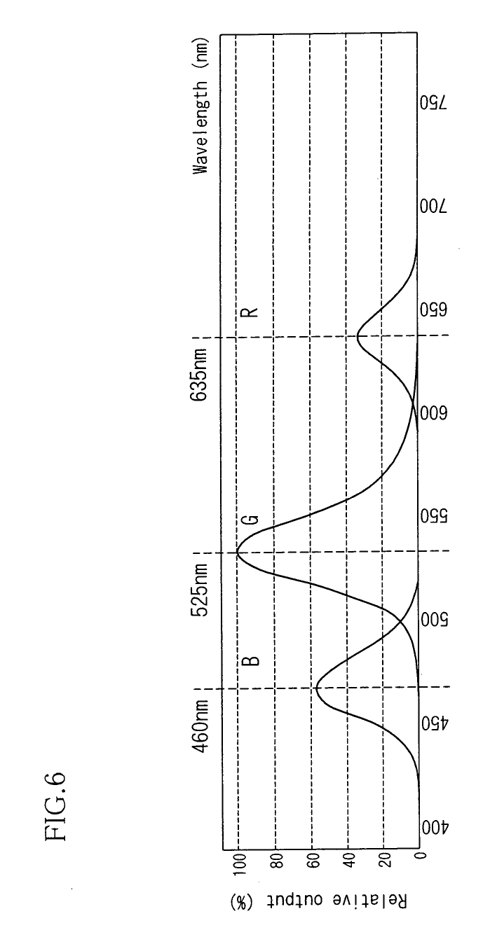

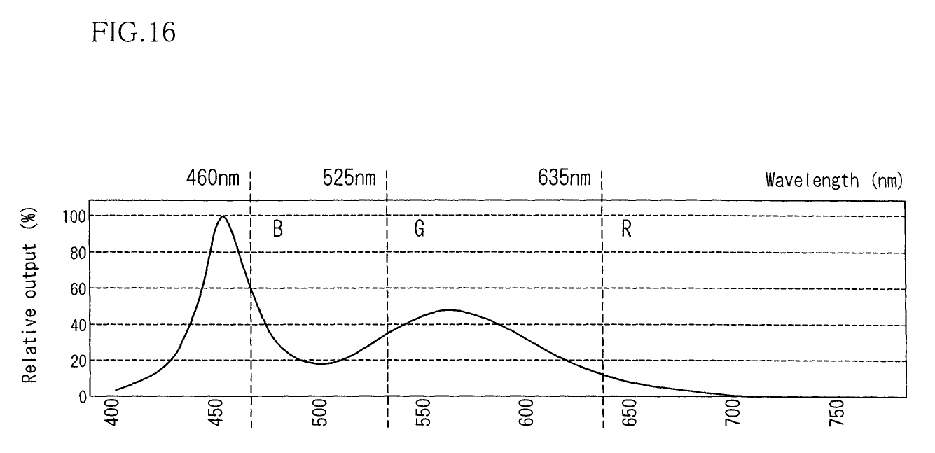

Spectral distribution of the respective colors RGB emitted by RGB tri-color LED 11 is in the present case as indicated at FIG. 6, with red intensity being higher than would be the case with the spectral distribution of a conventional white LED (see FIG. 16).

Here, taking Pr to be intensity associated with red LED chip 11r, Pg to be intensity associated with green LED chip 11g, and Pb to be intensity associated with blue LED chip 11b for the same value of electric current (e.g., 35 mA), it is preferred that the respective LED elements be chosen such that the ratio among Pr, Pg, and Pb is approximately 3:7:1, more or less.

That is, CCD camera 12 is such that images are captured on a color-by-color basis, with intensity of the red signal being used to determine gain and with the signals for the other colors green and blue being amplified at that same gain. This being the case, where the intensity of the red signal used to determine gain is low, gain will be set to a very high level, causing the signals for the other colors green and blue to saturate; and conversely, where the intensity of the red signal used to determine gain is high, gain will be set to a very low level, causing the signals for the other colors green and blue to be overwhelmed by noise. Accordingly, setting this to a ratio such as the aforementioned (3:7:1) permits elimination of such problematic situations and allows satisfactory images to be acquired. Needless to say, however, this ratio may be adjusted as appropriate depending upon the combination of wavelengths of the respective LED elements.

The RGB tri-color LED 11 employed in the foregoing description being a working example (first working example) of the illumination apparatus of the present invention, other working examples of the illumination apparatus of the present invention are described below.

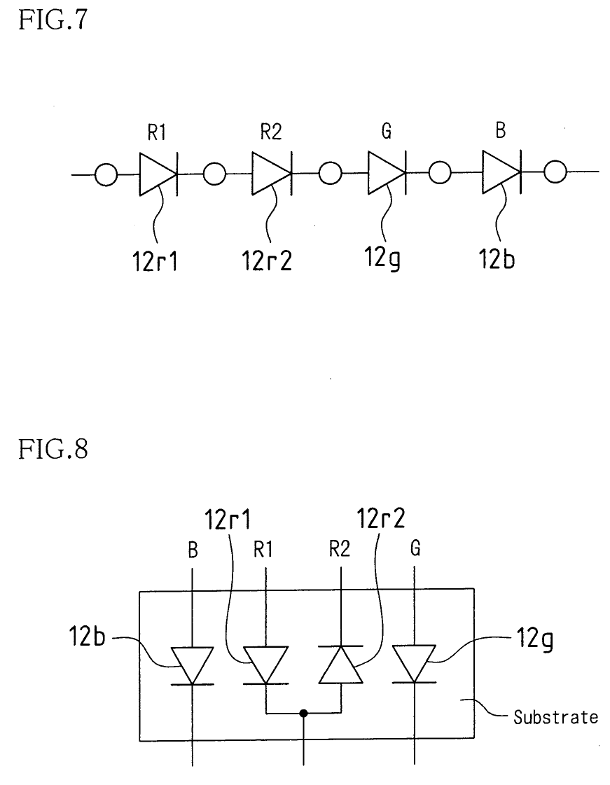

FIG. 7 shows an example of constitution viz a viz connections, and FIG. 8 shows an example of constitution viz a viz arrangement on board(s) or substrate(s), in an illumination apparatus in a second working example; the constitution being such that two red LED chips 12r1, 12r2, one green LED chip 12g, and one blue LED chip 12b are connected in series, with these four chips 12r, 12g, 12b being driven by one power supply apparatus (battery).

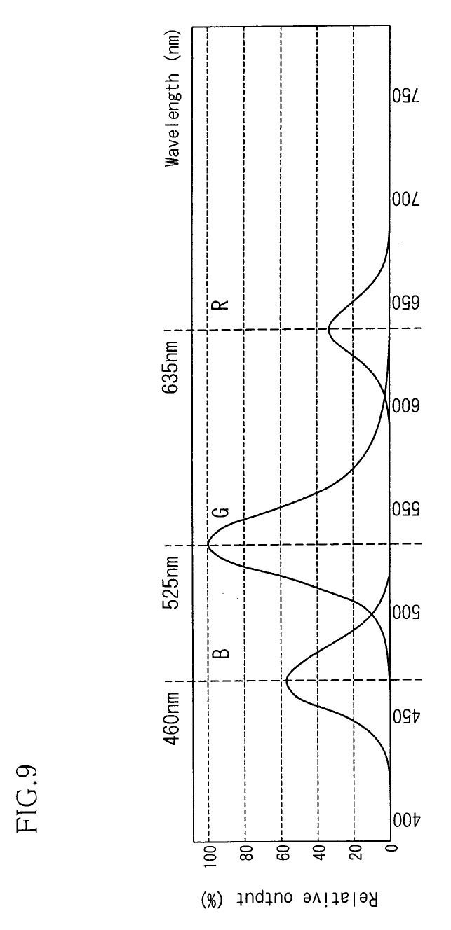

Spectral distribution of the colors emitted by the respective chips is in the present case as indicated at FIG. 9. That is, connection of two red LED chips produces a red intensity that is higher than would be the case with the spectral distribution of a conventional white LED (see FIG. 16).

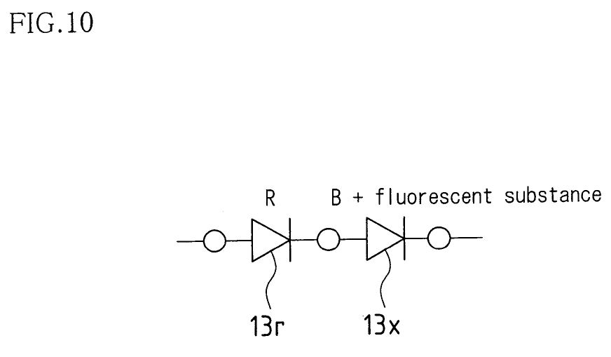

FIG. 10 shows an example of constitution viz a viz connections in an illumination apparatus in a third working example; the constitution being such that red LED chip 13r and chip 13x comprising a blue chip and a fluorescent substance are connected in series, with these chips 13r, 13x being driven by one power supply apparatus (battery).

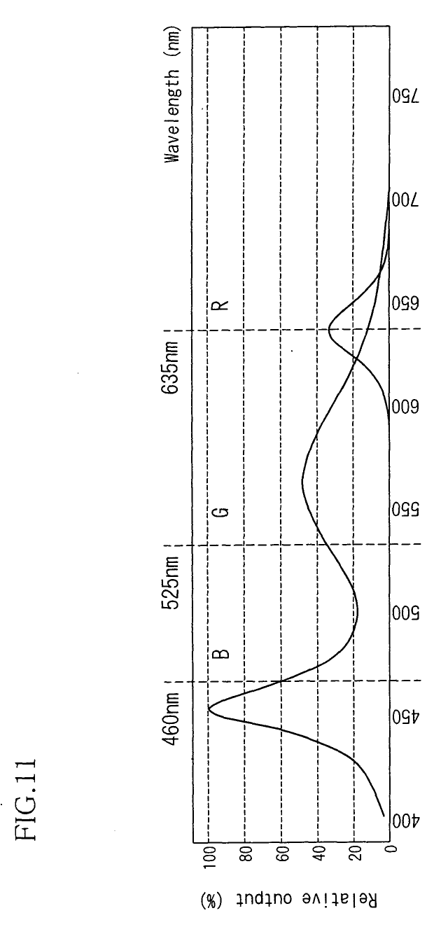

Spectral distribution of the colors emitted by the respective chips is in the present case as indicated at FIG. 11. That is, while the red component would be insufficient with chip 13x comprising a blue chip and a fluorescent substance, addition of red LED chip 13r hereto makes it possible to improve color reproduction by CCD camera 12. Furthermore, the illumination apparatus of the present third working example makes it possible to reduce from three chips to two chips the number of chips which must be provided.

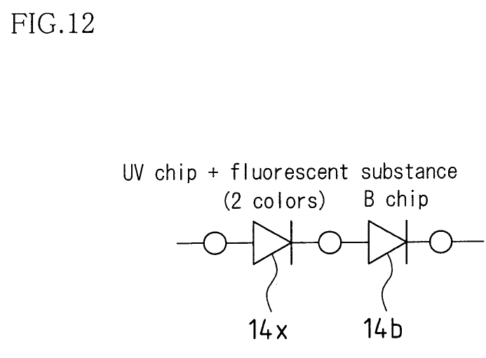

FIG. 12 shows an example of constitution viz a viz connections in an illumination apparatus in a fourth working example; the constitution being such that blue LED chip 14b and UV (ultraviolet) chip 14x capable of causing excitation so as to produce red and so as to produce green due to combination of a violet chip and a fluorescent substance are connected in series, with these chips 14x, 14b being driven by one power supply apparatus (battery).

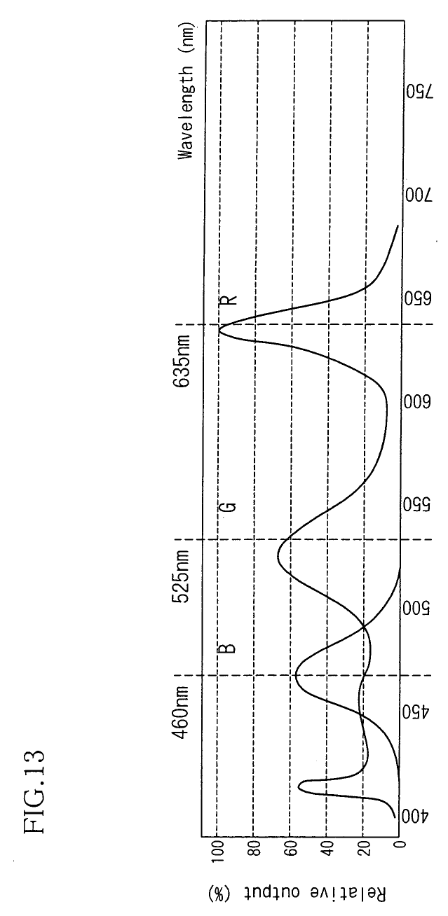

Spectral distribution of the colors emitted by the respective chips is in the present case as indicated at FIG. 13. That is, while UV chip 14x permits attainment of two wavelengths, these being red and green, addition of blue LED chip 14b hereto makes it possible to compensate for the relative weakness of the color at the blue wavelength and makes it possible to improve color reproduction by CCD camera 12.

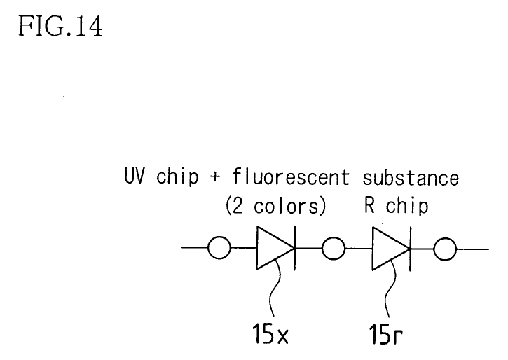

FIG. 14 shows an example of constitution viz a viz connections in an illumination apparatus in a fifth working example; the constitution being such that red LED chip 15r and UV chip 15x capable of causing excitation so as to produce green and so as to produce blue due to combination of a violet chip and a fluorescent substance are connected in series, with these chips 15x, 15r being driven by one power supply apparatus (battery).

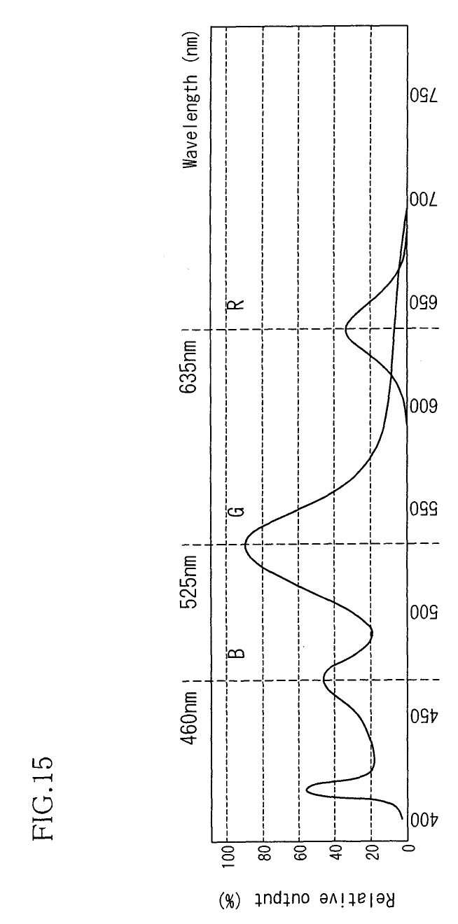

Spectral distribution of the colors emitted by the respective chips is in the present case as indicated at FIG. 15. That is, while UV chip 15x permits attainment of two wavelengths, these being green and blue, addition of red LED chip 15r hereto makes it possible to compensate for the relative weakness of the color at the red wavelength and makes it possible to improve color reproduction by CCD camera 12.

Note that, as above, it is also preferred in these second through fifth working examples that materials at the respective light emitting elements be chosen such that the ratio of the intensities among Pr, Pg, and Pb is approximately 3:7:1, more or less.

Furthermore, whereas the foregoing embodiments have been described in terms of an example wherein such illumination apparatus and CCD camera 12 are installed in a mobile telephone, the device in which these are installed is not limited to mobile telephones, it also being possible to install same in any of various portable equipment including PDAs. Furthermore, in such case, the illumination apparatus need not necessarily be installed in combination with CCD camera 12, it being possible to install the illumination apparatus alone in portable equipment.

The present invention may be embodied in a wide variety of forms other than those presented herein without departing from the spirit or essential characteristics thereof. The foregoing embodiments and working examples, therefore, are in all respects merely illustrative and are not to be construed in limiting fashion. The scope of the present invention being as indicated by the claims, it is not to be constrained in any way whatsoever by the body of the specification. All modifications and changes within the range of equivalents of the claims are moreover within the scope of the present invention.

Moreover, the present application claims right of benefit of prior filing date of Japanese Patent Application No. 2002-228763, the content of which is incorporated herein by reference in its entirety. Furthermore, all references cited in the present specification are specifically incorporated herein by reference in their entirety.

What is claimed is:

1. An illumination apparatus characterized in that one or more red light emitting diode chips, one or more green light emitting diode chips, and one or more blue light emitting diode chips are connected in series; these chips being capable of being driven by one power supply apparatus.

2. An illumination apparatus characterized in that two red light emitting diode chips, one green light emitting diode chip, and one blue light emitting diode chip are connected in series; these four chips being capable of being driven by one power supply apparatus.

3. An illumination apparatus characterized in that one or more red light emitting diode chips and one or more chips comprising one or more blue chips and one or more fluorescent substances are connected in series; these chips being capable of being driven by one power supply apparatus.

4. An illumination apparatus characterized in that one or more blue light emitting diode chips and one or more chips capable of causing excitation so as to produce red and so as to produce green due to combination of one or more violet chips and one or more fluorescent substances are connected in series; these chips being capable of being driven by one power supply apparatus.

5. An illumination apparatus characterized in that one or more red light emitting diode chips and one or more chips capable of causing excitation so as to produce green and so as to produce blue due to combination of one or more violet chips and one or more fluorescent substances are connected in series; these chips being capable of being driven by one power supply apparatus.

6. A camera apparatus characterized in that one or more illumination apparatuses according to any of claims 1 through 5 are integrally mounted to the apparatus body for illumination when using one or more CCD image pickup elements to acquire one or more images.

7. A camera apparatus according to claim 6 characterized in that at least one gain of at least one of the CCD image pickup element or elements is set based on one or more signals associated with one or more specific wavelengths.

8. A camera apparatus according to claim 7 characterized in that, taking Pr to be red intensity, Pg to be green intensity, and Pb to be blue intensity for the same value of electric current, the ratio of the intensities among Pr, Pg, and Pb is 3:7:1, more or less.

9. Portable equipment characterized in that one or more camera apparatuses according to claim 6 are integrally mounted to the equipment body or bodies.

10. Portable equipment characterized in that one or more camera apparatuses according to claim 7 is integrally mounted to the equipment body or bodies

11. Portable equipment characterized in that one or more camera apparatuses according to claim 8 is integrally mounted to the equipment body or bodies.
